(19) United States
(12) Patent Application Publication
(10) Pub. No.: US 2026/0109634 A1
(43) Pub. Date: Apr. 23, 2026

(54) METHOD FOR TREATING AN AMMONICAL COPPER ETCHING PCB WASTEWATER

(71) Applicants: HITESHKUMAR PATEL, MAHESANA (IN); RUTKUMAR PATEL, MAHESANA (IN); HARSHILKUMAR PATEL, MAHESANA (IN); GITABEN PATEL, MAHESANA (IN); BHAVINKUMAR PATEL, MAHESANA (IN)

(72) Inventors: Hiteshkumar Dahyalal PATEL, Mahesana (IN); Rutkumar Hiteshbhai PATEL, Mahesana (IN); Harshilkumar Hiteshbhai PATEL, Mahesana (IN); Gitaben PATEL, Mahesana (IN); Bhavinkumar PATEL, Mahesana (IN)

(21) Appl. No.: 19/034,664

(22) Filed: Jan. 23, 2025

(30) Foreign Application Priority Data
Oct. 18, 2024 (IN) 202421079350

(51) Int. Cl. C02F 9/00; C01C 1/24; C02F 1/44; C02F 1/66; C02F 1/68; C02F 101/10; C02F 103/34; C22B 3/44; C22B 15/00

(52) U.S. Cl. CPC C02F 9/00; C01C 1/24; C02F 1/441; C02F 1/66; C02F 1/68; C02F 2101/10; C02F 2103/34; C22B 3/44; C22B 15/0089

(57) ABSTRACT

The present invention generally relates to a method of treating PCB wastewater. More specifically, the present invention relates to a method of ammonical copper etching of PCB wastewater and a process for treating the wastewater. The present invention also relates to the method of purifying the wastewater to reuse the same.

### TECHNICAL FIELD

The present invention is relates to a method of treating wastewater. More particularly, the present invention relates to treating an ammonical copper etching PCB wastewater. The present invention also relates to treating PCB wastewater by zero waste discharge and the process for treating the same.

### BACKGROUND OF THE INVENTION

The “PCB” is a printed circuit board, which is one of an important parts of the electronic industry, almost every kind of electronic equipment, small electronic watch, calculators, large-to-communication equipment and military weapon systems. The use amount of electronic equipment is increased as long as the life level of people has developed. The production and manufacturing of the PCB can generate a large amount of PCB wastewater, and the PCB harmful chemicals. Generated all the year around the world approximately 3 billion to 4 billion PCB wastewater treatment is generates, which has great harm to the ecological environment.

PCB fabrication process is a very complex and highly integrated technology, during which a large amount of wastewater is produced. The wastewater has a complex composition, contains a variety of heavy metals ions, metal complexes, organic polymer compounds, and various organic additives. A large number of metal ions and complexes such as copper, nickel, silver, tin and lead in PCB wastewater are harmful to animals, plants and the environment. The wastewater produced by PCB fabrication process also contains plenty of organic substances, such as surfactants, inks, resists, organic dispersants, brighteners, and other high concentrations of organic compounds, as well as ammonia, cyanide, fluoride, phosphorous and other pollutants. These substances can harmfully affect the water bodies and destroy the ecology of such water bodies. Such pollutants can also affect humans and cause various diseases.

In recent years, various countries have gradually increased environmental awareness, and PCB wastewater treatment becomes very important aspect to manage. Traditional PCB wastewater treatment and recovery of heavy metal purification treatment methods, the treatment results in more sludge and high processing costs. PCB wastewater treatment is mainly divided into chemical method and physical method. Chemical method comprises process of converting the pollutants in wastewater into an easily separable physical state, including chemical precipitation method, redox method, ion exchange method, and electrolysis method. The physical methods comprises process of enriching the pollutants in the wastewater or separate them easily separated physical state from the wastewater, so that the wastewater can reach the discharge standard, mainly including decanting method, electrodialysis, reverse osmosis and the like.

Production of PCB involves drilling, scrubbing, chemical cleaning, electroless deposition, photo imaging, pattern plating, resist stripping and etching as the major step. Chemical etching process is used to develop the circuit pattern in PCB's by removing the excess portion of copper from the copper clad laminate. The copper dissolved away by etching process is about 50-70% of that originally present on the board. PCB etching using acidic or alkaline cupric chloride is well established process. However, both function differently and have their own relative advantages and disadvantages. Ammonical etching has the advantage that it does not remove the tin/lead solder that protects the portions of the copper circuit but fine line etching is not achieved, which some products require.

As the increasing population has increased the use of electric instruments, the amount of PCB production has also increased. Due to increase in PCB production, there is an increase in the amount of wastewater generated due to this production. Thus, it becomes very necessary to treat such wastewater and making it suitable for reusing purposes. The inventors of the present invention, have developed a process for treating such PCB wastewater effectively and achieving fine line etching and making it possible for obtaining almost 80% of wastewater into reusable form.

### OBJECTIVE OF THE INVENTION

The present invention is to provide a method for treating PCB wastewater.

The main objective of the present invention is to provide a method for treating an ammonical copper etching PCB wastewater.

Another objective of the present invention is to provide a method of obtaining maximum amount of pure water.

Another objective of the present invention is to provide a method for treating an ammonical copper etching PCB wastewater that is highly efficient and effective.

Another objective of the present invention is to provide a method for treating an ammonical copper etching PCB wastewater to recover maximum water for reusing and zero waste discharge.

### SUMMARY OF THE INVENTION

The main aspect of the present invention is to provide a method for treating an ammonical copper etching PCB wastewater.

Another aspect of the present invention is to provide a method for treating an ammonical copper etching PCB wastewater, wherein the process comprises the following steps:
a) Adding an acid of pH 2 and copper solution in an ammonical copper etching PCB wastewater of pH 9 to 10, resulting in the separation of a hydroxide and washing water of neutral pH 7;
b) Mixing the washing water of step (a) with an acid having pH 2 and metal powder, resulting in the formation of copper powder and acidic water;
c) Packing the copper powder of step (b) and utilizing the acidic water for the further process;
d) Mixing the acidic water of step (c) with a metal carbonate and resulting in the formation of ammonia salted water and a metal sulphate;
e) Packing the sulphate obtained in the step (d) and utilizing the obtained ammonia salted water for the further process;
f) Passing the ammonia salted water of step (e) through a filtration process or plant to obtain neutral water and salted water;
g) Recycling the neutral water of step (f) for various purposes in the process plant;
h) Passing the salted water of step (g) in a vaporize system resulting in the formation of ferrous ammonium sulphate;
i) Packing the final ferrous ammonium sulphate of step (h) for further use.

### DESCRIPTION OF THE INVENTION

The main embodiment of the present invention is to provide a method for treating an ammonical copper etching PCB wastewater.

The present invention overcomes the aforesaid drawbacks of the above, and other objects, features and advantages of the present invention will now be described in greater detail. Also, the following description includes various specific details and are to be regarded as merely exemplary. Accordingly, those of ordinary skill in the art will recognize that: without departing from the scope and spirit of the present disclosure and its various embodiments there may be any number of changes and modifications described herein.

The wording herein below is implied in the common meaning of the definitions and statements as known to the versed in the art of pharmaceuticals and polymer science.

As used in this document, the singular forms “a”, “an” and “the” include plural references unless the context clearly dictates otherwise. Unless defined otherwise, all technical and scientific terms used herein have the same meanings as commonly understood by one of ordinary skill in the art.

Nothing in this disclosure is to be construed as an admission that the embodiments described in this disclosure are not entitled to antedate such disclosure by virtue of prior invention. As used in this document, the term “comprising” means “including, but not limited to.”

“Optional” or “optionally’ means that the subsequently described event or circumstance may or may not occur, and that the description includes instances where the event occurs and instances where it does not.

As used herein the term “PCB” means a printed circuit board that is a structure for assembling electronic components and their connections into a unified circuit that allows electrical current to pass between components.

As used herein the term “ammonical etching” is a process for etching copper with an ammonical etchant solution and reconditioning the etchant solution which process consumes only feed of oxygen and water for etching copper and produces only a small amount of pollutant.

As used herein the term “PCB etching” is the process of removing unwanted copper from the printed circuit board.

As used herein the term “zero waste discharge” or “zero liquid discharge” is a treatment process in which the plant discharges no liquid effluents into surface waters, in effect completely eliminating the environmental pollution associated with the treatment.

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into sub ranges as discussed above. Finally, as will be understood by one skilled in the art, a range includes each individual member.

As used herein, the term “about” means plus or minus 10% of the numerical value of the number with which it is being used.

The main embodiment of the present invention is to provide a method for treating an ammonical copper etching PCB wastewater, wherein the process comprises the following steps:
a) Adding an acid of pH 2 and copper solution in an ammonical copper etching PCB wastewater of pH 9 to 10, resulting in the separation of a hydroxide and washing water of neutral pH 7;
b) Mixing the washing water of step (a) with an acid having pH 2 and metal powder, resulting in the formation of copper powder and acidic water;
c) Packing the copper powder of step (b) and utilizing the acidic water for the further process;
d) Mixing the acidic water of step (c) with a metal carbonate and resulting in the formation of ammonia salted water and a metal sulphate;
e) Packing the sulphate obtained in the step (d) and utilizing the obtained ammonia salted water for the further process;
f) Passing the ammonia salted water of step (e) through a filtration process or plant to obtain neutral water and salted water;
g) Recycling the neutral water of step (f) for various purposes in the process plant;
h) Passing the salted water of step (g) in a vaporize system resulting in the formation of ferrous ammonium sulphate;
i) Packing the final ferrous ammonium sulphate of step (h) for further use.

According to another embodiment of the present invention, the said acid used is selected from but not limited to sulphuric acid, hydrochloric acid, nitric acid, carbonic acid, formic acid, citric acid and acetylsalicyclic acid.

As per another embodiment of the present invention, the said acid used is more preferably sulphuric acid.

According to another embodiment of the present invention, the said metal carbonate are selected from but not limited to calcium carbonate, sodium carbonate, sodium bicarbonate, sodium hydroxide and sodium oxide.

As per another embodiment of the present invention, the said metal carbonate used is more preferably calcium carbonate.

According to another embodiment of the present invention, the obtained ammonia salted water is purified through filtration process is selected from reverse osmosis, carbon treatment, membrane filtration, vacuum filtration, centrifugal filtration, gravity filtration and granular media filtration.

As per another embodiment of the present invention, the said filtration process more preferably used is reverse osmosis process.

According to another embodiment, the present invention relates to treating PCB wastewater by zero waste discharge.

As per another embodiment of the present invention, the copper powder, metal sulphate and ferrous ammonium sulphate obtained during the process are packed and utilized in different applications.

The invention is further illustrated by the following examples which are provided to be exemplary of the invention and do not limit the scope of the invention. While the present invention has been described in terms of its specific embodiments, certain modifications and equivalents will be apparent to those skilled in the art and are intended to be included within the scope of the present invention.

### EXAMPLE 1: PROCESS FOR TREATING PCB WASTEWATER

The process for treating an ammonical copper etching PCB wastewater comprises following steps:
a) 10 ml sulphuric acid of pH 2 and 80 ml copper solution was added in ammonical copper etching PCB wastewater, resulted in the separation of hydroxide and washing water of neutral pH 7;
b) The washing water of step (a) was mixed with 6 ml sulphuric acid having pH 2 and 2 gm iron powder, resulted in the formation of copper powder and acidic water;
c) Packed the copper powder of step (b) and utilized the acidic water for the further process;
d) Mixed the acidic water of step (c) with 10 gm of calcium carbonate and resulted in the formation of ammonia salted water and calcium sulphate;
e) Packed the calcium sulphate obtained in the step (d) and used the obtained ammonia salted water for the further process;
f) Passed the ammonia salted water of step (e) in a reverse osmosis plant to obtain 80% neutral water and 20% salted water;
g) Recycled the neutral water of step (f) for various purposes in the process plant;
h) Passed the 20% salted water of step (g) in a vaporize system resulting in the formation of ferrous ammonium sulphate;
i) Packed the final ferrous ammonium sulphate of step (h) for further use.

### Conclusion

The present invention relates to treating an ammonical copper etching of PCB wastewater and treating the PCB wastewater to the extent of reusing the same for various purposes. The present invention also relates to obtaining ferrous ammonium sulphate as the end product.

We claim:

1. A method for treating an ammonical copper etching PCB wastewater, wherein the process comprises the following steps:
a) Adding an acid of pH 2 and copper solution in an ammonical copper etching PCB wastewater of pH 9 to 10, resulting in the separation of a hydroxide and washing water of neutral pH 7;
b) Mixing the washing water of step (a) with an acid having pH 2 and metal powder, resulting in the formation of copper powder and acidic water;
c) Packing the copper powder of step (b) and utilizing the acidic water for the further process;
d) Mixing the acidic water of step (c) with a metal carbonate and resulting in the formation of ammonia salted water and a metal sulphate;
e) Packing the sulphate obtained in the step (d) and utilizing the obtained ammonia salted water for the further process;
f) Passing the ammonia salted water of step (e) through a filtration process or plant to obtain neutral water and salted water;
g) Recycling the neutral water of step (f) for various purposes in the process plant;
h) Passing the salted water of step (g) in a vaporize system resulting in the formation of ferrous ammonium sulphate;
i) Packing the final ferrous ammonium sulphate of step (h) for further use.

2. The method for treating an ammonical copper etching PCB wastewater as claimed in claim 1, wherein the acid used is selected from but not limited to sulphuric acid, hydrochloric acid, nitric acid, carbonic acid, formic acid, citric acid and acetylsalicyclic acid.

3. The method for treating an ammonical copper etching PCB wastewater as claimed in claim 1, wherein the used metal carbonate are selected from but not limited to calcium carbonate, sodium carbonate, sodium bicarbonate, sodium hydroxide and sodium oxide.

4. The method for treating an ammonical copper etching PCB wastewater as claimed in claim 1, wherein the obtained ammonia salted water is purified through filtration process is selected from reverse osmosis, carbon treatment, membrane filtration, vacuum filtration, centrifugal filtration, gravity filtration and granular media filtration.

5. The method for treating an ammonical copper etching PCB wastewater as claimed in claim 1, wherein the process comprises the following steps:
a) Adding 10 ml sulphuric acid of pH 2 and 80 ml copper solution in an ammonical copper etching PCB wastewater, resulting in the separation of hydroxide and washing water of neutral pH 7;
b) Mixing the washing water of step (a) with 6 ml sulphuric acid having pH 2 and 2 gm iron powder, resulting in the formation of copper powder and acidic water;
c) Packing the copper powder of step (b) and utilizing the acidic water for the further process;
d) Mixing the acidic water of step (c) with 10 gm of calcium carbonate and resulting in the formation of ammonia salted water and calcium sulphate;
e) Packing the calcium sulphate obtained in the step (d) and using the obtained ammonia salted water for the further process;
f) Passing the ammonia salted water of step (e) in a reverse osmosis plant to obtain 80% neutral water and 20% salted water;
g) Recycling the neutral water of step (f) for various purposes in the process plant;
h) Passing the 20% salted water of step (g) in a vaporize system resulting in the formation of ferrous ammonium sulphate;
i) Packing the final ferrous ammonium sulphate of step (h) for further use.
